(19) United States
(12) Patent Application Publication
(10) Pub. No.: US 2025/0377477 A1
(43) Pub. Date: Dec. 11, 2025

(54) PETROPHYSICAL EVALUATION FROM NON-RADIOACTIVE MEASUREMENTS AND MUDLOGGING DATA THROUGH DENSITY AND NEUTRON POROSITY LOG RECONSTRUCTION

(71) Applicant: Schlumberger Technology Corporation, Sugar Land, TX (US)

(72) Inventors: Francisco Alamilla Martinez, Rio de Janeiro (BR); Luis Manuel Lavin Vizcaino, Bogota (CO)

(21) Appl. No.: 18/735,051

(22) Filed: Jun. 5, 2024

(51) Int. Cl. G01V 11/00; E21B 49/08

(52) U.S. Cl. CPC G01V 11/002; E21B 49/08

(57) ABSTRACT

A method for forecasting productivity in a subsurface formation includes receiving input data. The input data includes first input data and second input data. The method also includes determining a bulk density curve and a neutron porosity curve based upon the first input data and the second input data. The method also includes determining a permeability in the subsurface formation based at least partially upon the bulk density curve and the neutron porosity curve. The method also includes determining a rock type in the subsurface formation based upon the permeability.

### BACKGROUND

Petrophysical evaluation is performed to determine the presence of hydrocarbons in a subsurface formation and/or to determine where or how to drill to reach the hydrocarbons. More particularly, petrophysical evaluation is performed by geoscientists, petrophysicists, and reservoir engineers to assess and interpret well logs and formation evaluation data to optimize hydrocarbon recovery and production operations.

As petrophysical evaluations are performed manually by users, it may be time-consuming and expensive. In addition, oftentimes, some of the data (e.g., well logs, formation evaluation data, etc.) is missing, incomplete, or low-quality, which makes the process too difficult for the users to complete.

Therefore, what is needed is an improved system and method for performing petrophysical evaluation to forecast productivity in a subsurface formation.

### SUMMARY

A method for forecasting productivity in a subsurface formation includes receiving input data. The input data includes first input data and second input data. The method also includes determining a bulk density curve and a neutron porosity curve based upon the first input data and the second input data. The method also includes determining a permeability in the subsurface formation based at least partially upon the bulk density curve and the neutron porosity curve. The method also includes determining a rock type in the subsurface formation based upon the permeability.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data includes first input data and second input data. The first input data includes gamma ray measurements, resistivity measurements, and borehole deviation measurements. The second input data includes methane measurements, total clay volume measurements, non-clay siliciclastics measurements, and calcite measurements. The operations also include determining a bulk density curve based upon the input data. The bulk density curve is based upon the gamma ray measurements, the resistivity measurements, the borehole deviation measurements, the methane measurements, the total clay volume measurements, and the non-clay siliciclastics measurements. The operations also include determining a neutron porosity curve based upon the input data. The neutron porosity curve is based upon the gamma ray measurements, the resistivity measurements, the methane measurements, the total clay volume measurements, and the non-clay siliciclastics measurements. The operations also include determining a shale volume based upon the bulk density curve and the neutron porosity curve. The operations also include determining a total porosity based upon the bulk density curve and the neutron porosity curve. The operations also include determining an effective porosity based upon the shale volume and the total porosity. The operations also include determining a water saturation based upon the shale volume, the total porosity, and the effective porosity. The operations also include determining a permeability based upon the total porosity, the effective porosity, and water saturation. The operations also include determining a rock type in a subsurface formation based upon the permeability.

A non-transitory computer-readable medium is also disclosed. The medium stores instructions that, when executed by one or more processors of a computing system, cause the computing system to perform operations. The operations include receiving input data. The input data includes first input data and second input data. The first input data is from a logging-while-drilling tool and/or a wireline tool. The first input data includes gamma ray measurements, resistivity measurements, and borehole deviation measurements. The second input data is from a mudlogging tool. The second input data includes methane measurements, total clay volume measurements, non-clay siliciclastics measurements, and calcite measurements. The operations also include determining a bulk density curve based upon the input data. The bulk density curve is based upon the gamma ray measurements, the resistivity measurements, the borehole deviation measurements, the methane measurements, the total clay volume measurements, and the non-clay siliciclastics measurements. The bulk density curve is generated using a machine-learning (ML) model. The ML model includes a Gradient Boosted Trees model or a XGBoost model. The operations also include determining a neutron porosity curve based upon the input data. The neutron porosity curve is based upon the gamma ray measurements, the resistivity measurements, the methane measurements, the total clay volume measurements, and the non-clay siliciclastics measurements. The neutron porosity curve is generated using the ML model. The operations also include determining a shale volume curve based upon the bulk density curve and the neutron porosity curve. The shale volume curve is also determined based upon the gamma ray measurements and the total clay volume measurements. The shale volume curve is determined by a Gradient Boosted Trees ML algorithm with previously expert-interpreted shale volumes as a shale volume target variable. The Gradient Boosted Trees ML algorithm uses direct rock evidence obtained from cuttings in a subsurface formation to improve accuracy by reducing ambiguity when determining a shale volume estimation derived from the first input data. The shale volume estimation also incorporates evidence gathered via the second input data to enhance precision while sustaining a detail level of the first input data. The operations also include determining a total porosity curve based upon the bulk density curve and the neutron porosity curve. The total porosity is also determined based upon the total clay volume measurements, the non-clay siliciclastics measurements, and the calcite measurements. The total porosity curve is determined by creating a new total porosity feature by multiplying the bulk density curve and the neutron porosity curve to create a total porosity product and introducing the total porosity product into the Gradient Boosted Trees ML algorithm with previously expert-interpreted total porosity volumes as a total porosity target variable. The Gradient Boosted Trees ML algorithm uses the direct rock evidence obtained from the cuttings to improve accuracy by reducing ambiguity when determining a total porosity estimation derived from the first input data. The total porosity estimation also incorporates evidence gathered via the second input data to enhance precision while sustaining a detail level of the first input data. The operations also include determining an effective porosity curve based upon the shale volume curve and the total porosity curve. The effective porosity curve is determined by creating a new effective porosity feature by multiplying the shale volume curve and the total porosity curve to create an effective porosity product and then introducing the effective porosity product into the Gradient Boosted Trees ML algorithm with previously expert-interpreted effective porosity volumes as an effective porosity target variable. The operations also include determining a water saturation curve based upon the shale volume curve, the total porosity curve, and the effective porosity curve. The water saturation curve is also determined based upon the gamma ray measurements and the methane measurements. The water saturation curve is determined by introducing the shale volume curve, the total porosity curve, and the effective porosity curve into the Gradient Boosted Trees ML algorithm with previously expert-interpreted water saturation as a water saturation target variable. The Gradient Boosted Trees ML algorithm uses direct fluid evidence obtained from gas chromatography in the subsurface formation to improve accuracy by reducing ambiguity when determining a water saturation estimation derived from the first input data. The water saturation estimation also incorporates evidence gathered via the second input data to enhance precision while sustaining a detail level of the first input data. The operations also include determining a permeability curve based upon the total porosity curve, the effective porosity curve, and water saturation curve. The permeability is determined by creating new permeability features multiplying the total porosity curve and the water saturation curve to create a permeability product and introducing the permeability product into the Gradient Boosted Trees ML algorithm with previously expert-interpreted permeability as a permeability target variable. The operations also include determining a rock type in the subsurface formation based upon the permeability curve. The rock type is determined by creating new rock type features by squaring and obtaining a base10 logarithm of the permeability curve and then introducing the base10 logarithm of the permeability curve into a Random Forest classification algorithm with previously expert-interpreted rock type as a rock type target variable.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for forecasting productivity in a subsurface formation, according to an embodiment.

FIG. 3 illustrates a schematic view of the method in FIG. 2, according to an embodiment.

FIGS. 4A and 4B illustrate an image of data that is input into and/or output from the method in FIG. 2, according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

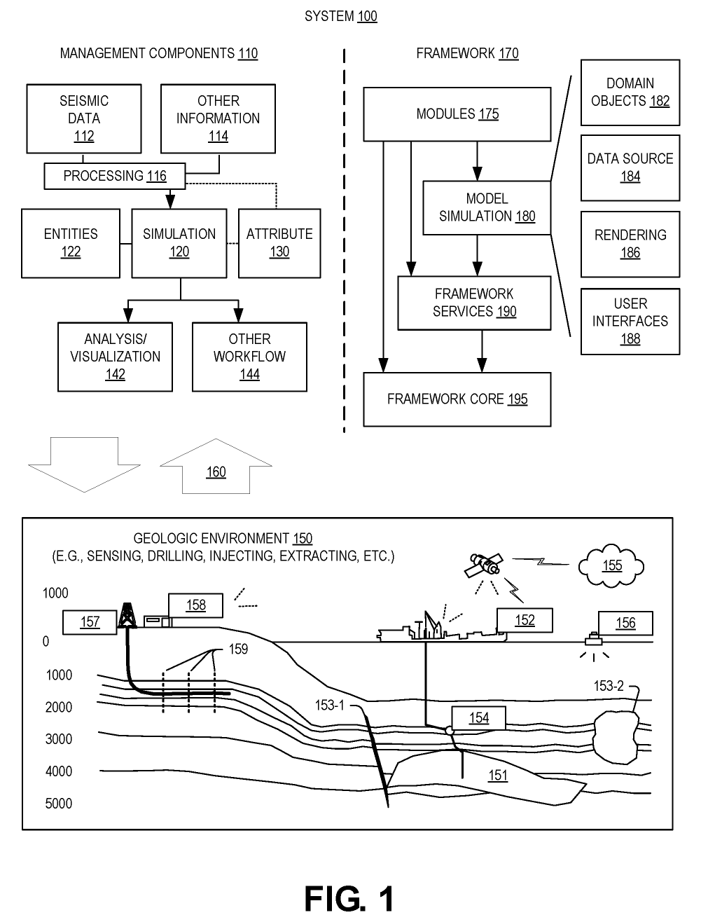

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

Cascading Ensemble Method to Obtain Petrophysical Evaluation from Non-Radioactive Measurements and Mudlogging Data through Density and Neutron Porosity Log Reconstruction

The present disclosure pertains to a cascading ensemble method for obtaining petrophysical evaluation from non-radioactive measurements and mudlogging data via density and neutron porosity log reconstruction. The technology may be applicable in the field of petroleum exploration and production, particularly in analyzing reservoir properties and fluid content in subsurface formations. The method is designed to be used by geoscientists, petrophysicists, and reservoir engineers, and others who are involved in the assessment and interpretation of well logs and formation evaluation data for optimizing hydrocarbon recovery and production operations, particularly in fields where data is missing, incomplete, or has low-quality.

The method may be or include a machine-learning (ML) cascading ensemble method that combines mudlogging data and logging-while-drilling data (e.g., gamma ray, resistivity, and/or inclination measurements) to produce a complete petrophysical evaluation through the creation of synthetic density and porosity curves. The results obtained may then be introduced sequentially into individual ML algorithms that provide calculations of shale volume, total porosity, effective porosity, water saturation, permeability, and rock typing sequentially, using the inputs from the previous step. As a byproduct of this process, the synthetic density and neutron curves can also serve as quality control (QC) or curve infilling when actual density and neutron curves are being logged. This methodology provides an accurate petrophysical evaluation which does not use additional user input, as it transfers the knowledge previously gathered in the same play to newly drilled wells, reducing interpreter bias and speeding up interpretation times.

Due to the speed of ML algorithm, it can be used in real-time operations to provide an initial interpretation of hydrocarbon presence and/or rock quality downhole, which can be then piped down to other processes as completion design and/or productivity forecasting. In addition, if there is a neutron-density tool in the wellbore, synthetic curves may be used to quickly determine outliers in the measurements, as these tools may be prone to be affected by washouts, calibration issues, or tool failures. The method may also reduce the time and increase the accuracy when doing field-wide evaluations where the data is limited to mudlogging, gamma ray, and resistivity logs.

As mentioned above, the method may be used to estimate the hydrocarbon volume in oil and gas wells. This may be particularly helpful in cases where conventional logging techniques are too expensive or too risky. The method also provides a proper characterization of the synthetic curves, as the learning part of the algorithm targets a common ground target at each part of the process, preserving the criteria and information gathered in previous wells. During the initial trial of the algorithm, a 0.05% difference in NTG calculation was obtained with reference to manually interpreted data. In this same test, the average time to process 1,000 ft of logs was 36 seconds. Due to the speed and accuracy of the method, it can be used when time is short, such as completion planning (e.g., slotted liner/perforations), geo-steering, and even feed real-time production simulations. In one embodiment, the method may run natively inside Techlog and use Dataiku as a backend through an API, allowing seamless communication for the user, leaving a copy of the resulting process in a format that the user can further analyze and refine.

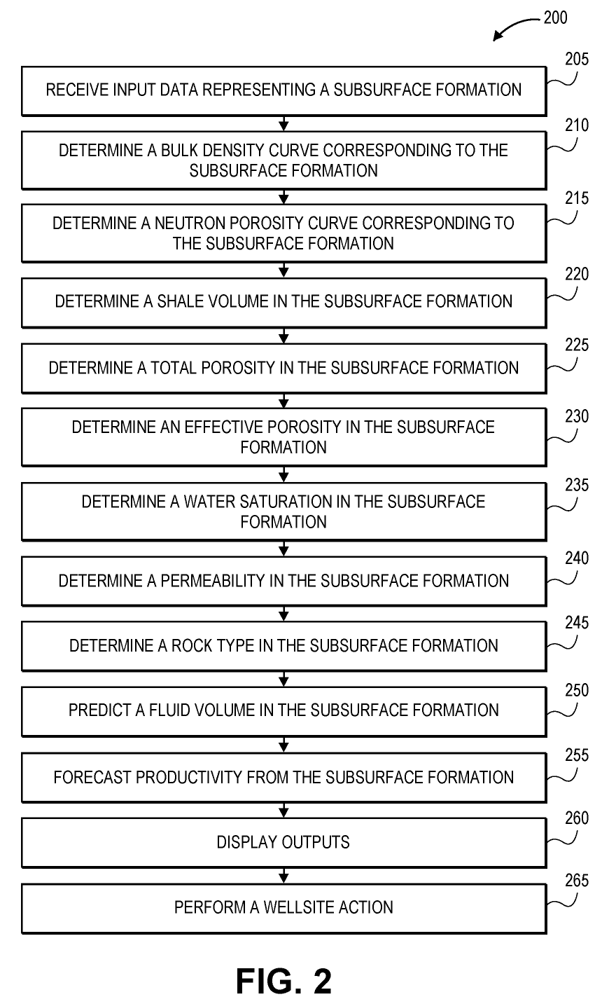

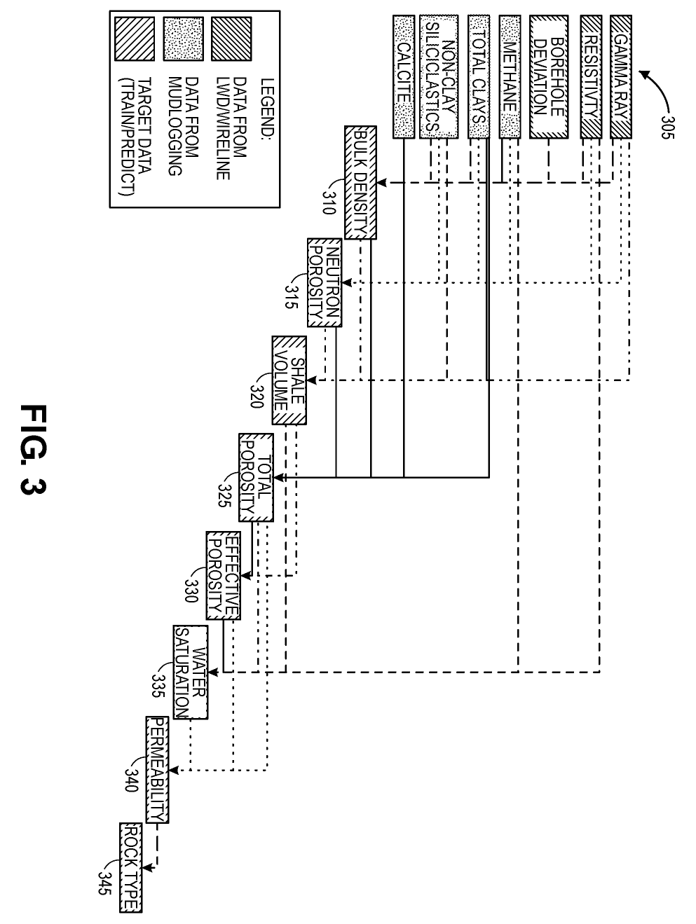

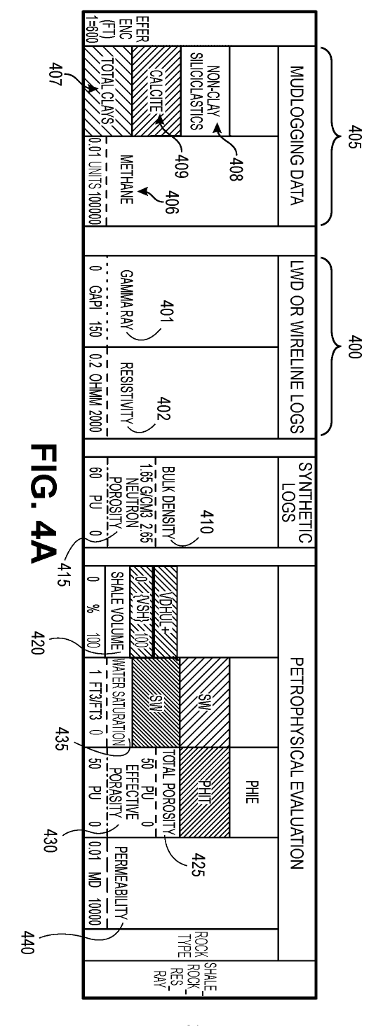

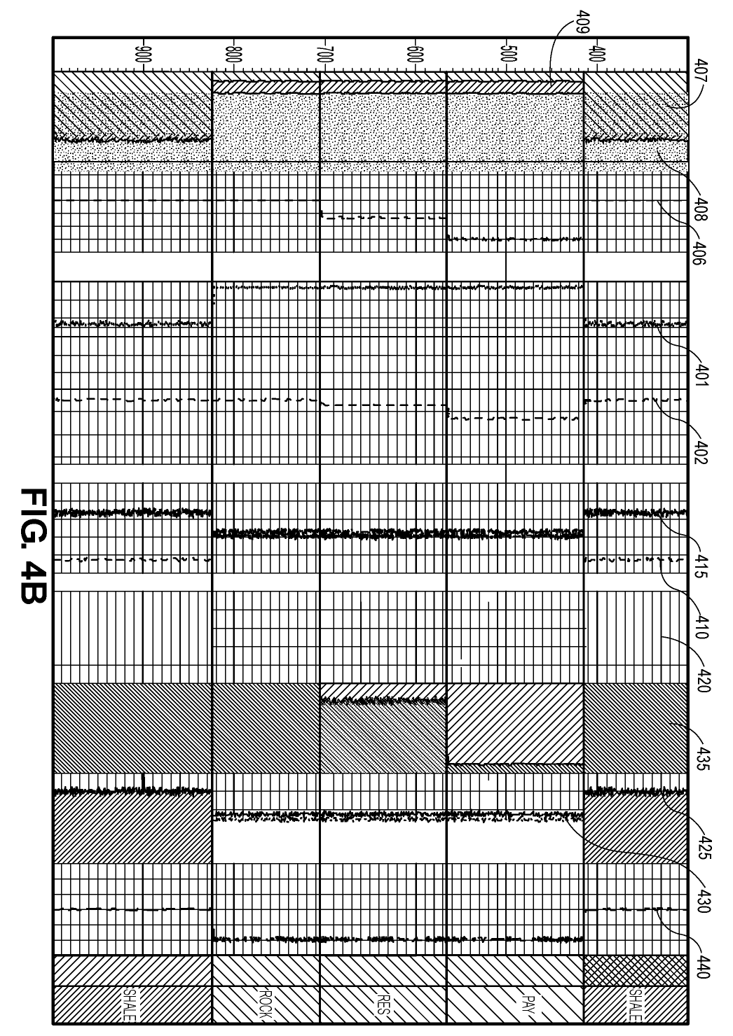

FIG. 2 illustrates a flowchart of a method 200 for forecasting productivity in a subsurface formation, according to an embodiment. An illustrative order of the method 200 is provided below; however, one or more portions of the method 200 may be performed in a different order, simultaneously, repeated, or omitted. At least a portion of the method 200 may be performed by a computing system 500 (described below). FIG. 3 illustrates a schematic view of the method 200, according to an embodiment. FIGS. 4A and 4B illustrate an image of data that may be input into and/or output from the method 200, according to an embodiment. FIGS. 4A and 4B are a single data log, where FIG. 4A represents the reference numbers and legend, and FIG. 4B represents the data itself. For example, the data may include mudlogging data, LWD or wireline data, synthetic logs, and petrophysical evaluation.

The method 200 may include receiving input data, as at 205 corresponding to the subsurface formation. This is also shown at 305 in FIG. 3. As shown in FIGS. 4A and 4B, the input data may be or include first input data 400 and second input data 405. The first input data 400 may be from a logging-while-drilling tool and/or a wireline tool. The first input data 400 may be or include gamma ray measurements 401, resistivity measurements 402, borehole deviation measurements, or a combination thereof. The second input data 405 may be from a mudlogging tool. The second input data 405 may be or include methane measurements 406, total clay volume measurements 407, non-clay siliciclastics measurements 408, calcite measurements 409, or a combination thereof.

The method 200 may also include determining or generating a bulk density curve, as at 210. This is also shown at 310 in FIG. 3 and at 410 in FIGS. 4A and 4B. The bulk density curve 410 may be generated synthetically (e.g., simulated) based upon the input data. More particularly, the bulk density curve 410 may be generated based upon the gamma ray measurements 401, the resistivity measurements 402, the borehole deviation measurements, the methane measurements 406, the total clay volume measurements 407, the non-clay siliciclastics measurements 408, or a combination thereof. In one embodiment, the bulk density curve 410 may not be determined based upon the calcite measurements 409. The bulk density curve 410 may be determined using a machine-learning (ML) model. The ML model may be or include a Gradient Boosted Trees model or a XGBoost model.

The method 200 may also include determining or generating a neutron porosity curve, as at 215. This is also shown at 315 in FIG. 3 and at 415 in FIGS. 4A and 4B. The neutron porosity curve 415 may be generated synthetically based upon the input data. More particularly, the neutron porosity curve 415 may be based upon the gamma ray measurements 401, the resistivity measurements 402, the methane measurements 406, the total clay volume measurements 407, the non-clay siliciclastics measurements 408, or a combination thereof. In one embodiment, the neutron porosity curve 415 may not be determined (e.g., directly) based upon the borehole deviation measurements and/or the calcite measurements 409. The neutron porosity curve 415 may be determined using the ML model.

The method 200 may also include determining a shale volume, as at 220. This is also shown at 320 in FIG. 3 and at 420 in FIGS. 4A and 4B. Determining the shale volume 420 may include generating a shale volume curve. The shale volume 420 may be determined based upon the bulk density curve 410 and/or the neutron porosity curve 415. The shale volume curve 420 may also or instead be determined based upon the gamma ray measurements 401 and the total clay volume measurements 407. In one embodiment, the shale volume 420 may not be determined (e.g., directly) based upon the resistivity measurements 402, the borehole deviation measurements, the methane measurements 406, the non-clay siliciclastics measurements 408, and/or the calcite measurements 409. The shale volume may be determined by a Gradient Boosted Trees ML algorithm with previously expert-interpreted shale volumes as a shale volume target variable. The Gradient Boosted Trees ML algorithm may use direct rock evidence obtained from cuttings (e.g., in the subsurface formation) to improve accuracy by reducing ambiguity when determining a shale volume estimation derived from the first input data 400. This estimation may also incorporate evidence gathered via the second input data 405 to enhance precision while sustaining the detail level of the first input data 400.

The method 200 may also include determining a total porosity, as at 225. This is also shown at 325 in FIG. 3 and at 425 in FIGS. 4A and 4B. Determining the total porosity 425 may include generating a total porosity curve. The total porosity 425 may be determined based upon the bulk density curve 410 and/or the neutron porosity curve 415. The total porosity 425 may also or instead be determined based upon the total clay volume measurements 407, the non-clay siliciclastics measurements 408, the calcite measurements 409, or a combination thereof. In one embodiment, the total porosity 425 may not be determined (e.g., directly) based upon the gamma ray measurements 401, the resistivity measurements 402, the borehole deviation measurements, and/or the methane measurements 406. The total porosity 425 may be determined by creating a new total porosity feature by (1) multiplying the bulk density curve 410 and the neutron porosity curve 415 to create a total porosity product and (2) introducing the total porosity product into the Gradient Boosted Trees ML algorithm with previously expert-interpreted total porosity volumes as a total porosity target variable. The Gradient Boosted Trees ML algorithm may use the direct rock evidence obtained from the cuttings to improve accuracy by reducing ambiguity when determining a total porosity estimation derived from the first input data 400. This estimation may also incorporate evidence gathered via the second input data 405 to enhance precision while sustaining the detail level of the first input data 400.

The method 200 may also include determining an effective porosity, as at 230. This is also shown at 330 in FIG. 3 and at 430 in FIGS. 4A and 4B. Determining the effective porosity 430 may include generating an effective porosity curve. The effective porosity 430 may be determined based upon the shale volume 420 and/or the total porosity 425. In one embodiment, the effective porosity 430 may not be determined (e.g., directly) based upon the input data. In another embodiment, the effective porosity 430 may not be determined (e.g., directly) based upon the bulk density curve 410 and/or the neutron porosity curve 415. The effective porosity 430 may be determined by creating a new effective porosity feature by (1) multiplying the shale volume 420 and the total porosity 425 to create an effective porosity product and then (2) introducing the effective porosity product into the Gradient Boosted Trees ML algorithm with previously expert-interpreted effective porosity volumes as an effective porosity target variable.

The method 200 may also include determining a water saturation, as at 235. This is also shown at 335 in FIG. 3 and at 435 in FIGS. 4A and 4B. Determining the water saturation 435 may include generating a water saturation curve. The water saturation 435 may be based upon the shale volume 420, the total porosity 425, and/or the effective porosity 430. The water saturation 435 may also be determined based upon the gamma ray measurements 401 and/or the methane measurements 406. In one embodiment, the water saturation 435 may not be determined (e.g., directly) based upon the resistivity measurements 402, the borehole deviation measurements, the methane measurements 406, the total clay volume measurements 407, non-clay siliciclastics measurements 408, and/or calcite measurements 409. In another embodiment, the water saturation 435 may not be determined (e.g., directly) based upon the bulk density curve 410 and/or the neutron porosity curve 415. The water saturation 435 may be determined by introducing the shale volume 420, the total porosity 425, and/or the effective porosity 430 into the Gradient Boosted Trees ML algorithm with previously expert-interpreted water saturation as a water saturation target variable. The Gradient Boosted Trees ML algorithm may use direct fluid evidence obtained from gas chromatography in the subsurface formation to improve accuracy by reducing ambiguity when determining a water saturation estimation derived from the first input data 400. This estimation may also incorporate evidence gathered via the second input data 405 to enhance precision while sustaining the detail level of the first input data 400.

The method 200 may also include determining a permeability, as at 240. This is also shown at 340 in FIG. 3 and at 440 in FIGS. 4A and 4B. Determining the permeability 440 may include generating a permeability curve. The permeability 440 may be determined based upon the total porosity 425, the effective porosity 430, and/or the water saturation 435. In one embodiment, the permeability 440 may not be determined (e.g., directly) based upon the input data. In another embodiment, the permeability 440 may not be determined (e.g., directly) based upon the bulk density curve 410, the neutron porosity curve 415, and/or the shale volume 420. The permeability 440 may be determined by creating new permeability features by (1) multiplying the total porosity 425 and the water saturation 435 to create a permeability product and (2) introducing the permeability product into the Gradient Boosted Trees ML algorithm with previously expert-interpreted permeability as a permeability target variable.

The method 200 may also include determining a rock type in the subsurface formation, as at 245. This is also shown at 345 in FIG. 3 and at 445 in FIGS. 4A and 4B. The rock type 445 may be based upon the permeability 440. In one embodiment, the rock type 445 may not be determined (e.g., directly) based upon the input data. In another embodiment, the rock type 445 may not be determined (e.g., directly) based upon the bulk density curve 410, the neutron porosity curve 415, the shale volume 420, the total porosity 425, the effective porosity 430, and/or the water saturation 435. The rock type 445 may be determined by creating new rock type features by (1) squaring and obtaining a base10 logarithm of the permeability curve 440 and then (2) introducing the base10 logarithm of the permeability curve 440 into a Random Forest classification algorithm with previously expert-interpreted rock type as a rock type target variable.

The method 200 may also include predicting a fluid volume in the subsurface formation, as at 250. The fluid volume may be determined based upon the shale volume 420, the total porosity 425, the effective porosity 430, the permeability 440, the rock type 445, or a combination thereof. The fluid volume may be predicted by geostatistically populating a 3D grid with the shale volume 420, the total porosity 425, the effective porosity 430, the permeability 440, and/or the rock type 445 and then initializing either by equilibrium or enumeration.

The method 200 may also include forecasting productivity in the subsurface formation, as at 255. The productivity may be forecasted based upon the shale volume 420, the total porosity 425, the effective porosity 430, the water saturation 435, the permeability 440, the rock type 445, and/or the fluid volume. The productivity may be forecasted by a numerical simulation engine.

The method 200 may also include displaying outputs, as at 260. The outputs may be or include the bulk density curve 410, the neutron porosity curve 415, the shale volume 420, the total porosity 425, the effective porosity 430, the water saturation 435, the permeability 440, the rock type 445, the fluid volume, the productivity, or a combination thereof.

The method 200 may also include performing a wellsite action, as at 265. The wellsite action may be performed in response to the bulk density curve 410, the neutron porosity curve 415, the shale volume 420, the total porosity 425, the effective porosity 430, the water saturation 435, the permeability 440, the rock type 445, the fluid volume, the forecasted productivity, or a combination thereof. The wellsite action may be or include generating or transmitting a signal that instructs or causes a physical action to occur. In one embodiment, the physical action may include drilling a wellbore, varying a trajectory of the wellbore, varying a weight or torque on a drill bit that is drilling the wellbore, varying a flow rate or concentration of a fluid that is pumped into the wellbore, or a combination thereof. In another embodiment, the physical action may be or include installing, modifying, actuating, and/or replacing a completion component at a wellsite (e.g., in a wellbore) such as a packer, a slotted tubular, or an inflow control device.

### Exemplary Computing System

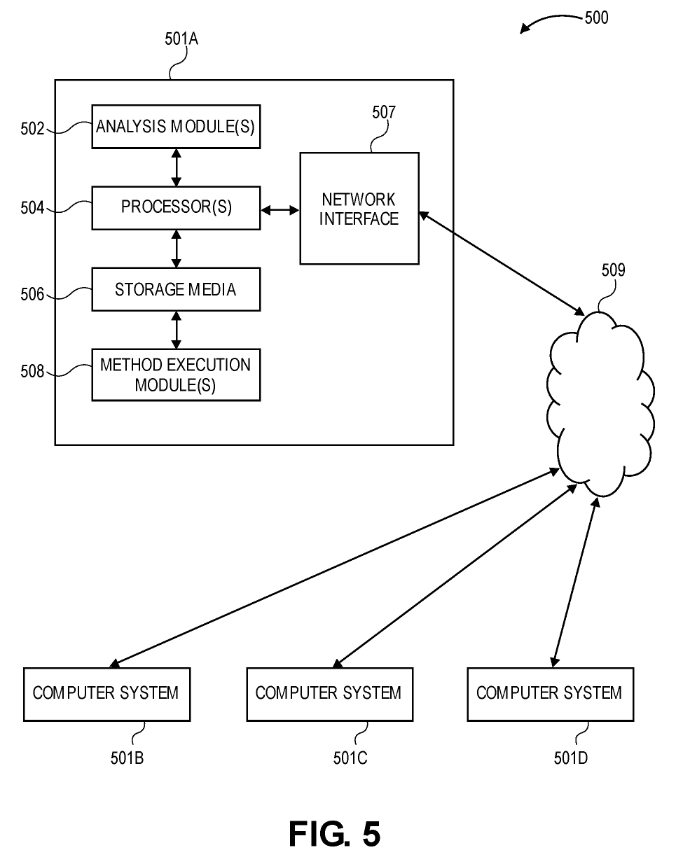

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more method execution module(s) 508. In the example of computing system 500, the computer system 501A includes the method execution module 508. In some embodiments, a single method execution module may be used to perform some aspects of one or more embodiments of the methods disclosed herein. In other embodiments, a plurality of method execution modules may be used to perform some aspects of methods herein.

It should be appreciated that computing system 500 is merely one example of a computing system, and that computing system 500 may have more or fewer components than shown, may combine additional components not depicted in the example embodiment of Figure 5, and/or computing system 500 may have a different configuration or arrangement of the components depicted in FIG. 5. The various components shown in Figure 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for forecasting productivity in a subsurface formation, the method comprising:
receiving input data, wherein the input data comprises first input data and second input data;
determining a bulk density curve based upon the first input data and the second input data;
determining a neutron porosity curve based upon the first input data and the second input data;
determining a permeability in the subsurface formation based at least partially upon the bulk density curve and the neutron porosity curve; and
determining a rock type in the subsurface formation based upon the permeability.

2. The method of claim 1, wherein the first input data is from a logging-while-drilling tool and/or a wireline tool, and wherein the second input data is from a mudlogging tool.

3. The method of claim 1, wherein the first input data comprises gamma ray measurements, resistivity measurements, and borehole deviation measurements, and wherein the second input data comprises methane measurements, total clay volume measurements, non-clay siliciclastics measurements, and calcite measurements.

4. The method of claim 3, wherein the bulk density curve is based upon the gamma ray measurements, the resistivity measurements, the borehole deviation measurements, the methane measurements, the total clay volume measurements, and the non-clay siliciclastics measurements.

5. The method of claim 3, wherein the neutron porosity curve is based upon the gamma ray measurements, the resistivity measurements, the methane measurements, the total clay volume measurements, and the non-clay siliciclastics measurements.

6. The method of claim 1, further comprising determining a shale volume based upon the bulk density curve and the neutron porosity curve, wherein the permeability is determined based at least partially upon the shale volume.

7. The method of claim 6, further comprising determining a total porosity based upon the bulk density curve and the neutron porosity curve, wherein the permeability is determined based at least partially upon the total porosity.

8. The method of claim 7, further comprising:
determining an effective porosity based upon the shale volume and the total porosity; and
determining a water saturation based upon the shale volume, the total porosity, and the effective porosity, wherein the permeability is based upon the total porosity, the effective porosity, and the water saturation.

9. The method of claim 1, further comprising displaying the permeability or the rock type.

10. The method of claim 1, further comprising performing a wellsite action in response to the permeability or the rock type, wherein the wellsite action comprises installing, modifying, or replacing a completion component, and wherein the completion component comprises a packer, a slotted tubular, or an inflow control device.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises first input data and second input data;
determining a bulk density curve based upon the input data;
determining a neutron porosity curve based upon the input data;
determining a shale volume based upon the bulk density curve and the neutron porosity curve;
determining a total porosity based upon the bulk density curve and the neutron porosity curve;
determining an effective porosity based upon the shale volume and the total porosity;
determining a water saturation based upon the shale volume, the total porosity, and the effective porosity;
determining a permeability based upon the total porosity, the effective porosity, and water saturation; and
determining a rock type in a subsurface formation based upon the permeability.

12. The computing system of claim 11, wherein the first input data comprises gamma ray measurements, resistivity measurements, and borehole deviation measurements, wherein the second input data comprises methane measurements, total clay volume measurements, non-clay siliciclastics measurements, and calcite measurements.

13. The computing system of claim 12, wherein the shale volume curve is also determined based upon the gamma ray measurements and the total clay volume measurements.

14. The computing system of claim 12, wherein the total porosity is also determined based upon the total clay volume measurements, the non-clay siliciclastics measurements, and the calcite measurements.

15. The computing system of claim 12, wherein the water saturation curve is also determined based upon the gamma ray measurements and the methane measurements.

16. A non-transitory computer-readable medium storing instructions that, when executed by one or more processors of a computing system, cause the computing system to perform operations, the operations comprising:
receiving input data, wherein the input data comprises first input data and second input data, wherein the first input data is from a logging-while-drilling tool and/or a wireline tool, wherein the first input data comprises gamma ray measurements, resistivity measurements, and borehole deviation measurements, wherein the second input data is from a mudlogging tool, and wherein the second input data comprises methane measurements, total clay volume measurements, non-clay siliciclastics measurements, and calcite measurements;
determining a bulk density curve based upon the input data, wherein the bulk density curve is based upon the gamma ray measurements, the resistivity measurements, the borehole deviation measurements, the methane measurements, the total clay volume measurements, and the non-clay siliciclastics measurements, wherein the bulk density curve is generated using a machine-learning (ML) model, and wherein the ML model comprises a Gradient Boosted Trees model or a XGBoost model;
determining a neutron porosity curve based upon the input data, wherein the neutron porosity curve is based upon the gamma ray measurements, the resistivity measurements, the methane measurements, the total clay volume measurements, and the non-clay siliciclastics measurements, and wherein the neutron porosity curve is generated using the ML model;
determining a shale volume curve based upon the bulk density curve and the neutron porosity curve, wherein the shale volume curve is also determined based upon the gamma ray measurements and the total clay volume measurements, wherein the shale volume curve is determined by a Gradient Boosted Trees ML algorithm with previously expert-interpreted shale volumes as a shale volume target variable, wherein the Gradient Boosted Trees ML algorithm uses direct rock evidence obtained from cuttings in a subsurface formation to improve accuracy by reducing ambiguity when determining a shale volume estimation derived from the first input data, and wherein the shale volume estimation also incorporates evidence gathered via the second input data to enhance precision while sustaining a detail level of the first input data;
. a total porosity curve based upon the bulk density curve and the neutron porosity curve, wherein the total porosity is also determined based upon the total clay volume measurements, the non-clay siliciclastics measurements, and the calcite measurements, wherein the total porosity curve is determined by creating a new total porosity feature by multiplying the bulk density curve and the neutron porosity curve to create a total porosity product and introducing the total porosity product into the Gradient Boosted Trees ML algorithm with previously expert-interpreted total porosity volumes as a total porosity target variable, wherein the Gradient Boosted Trees ML algorithm uses the direct rock evidence obtained from the cuttings to improve accuracy by reducing ambiguity when determining a total porosity estimation derived from the first input data, and wherein the total porosity estimation also incorporates evidence gathered via the second input data to enhance precision while sustaining a detail level of the first input data;
. an effective porosity curve based upon the shale volume curve and the total porosity curve, wherein the effective porosity curve is determined by creating a new effective porosity feature by multiplying the shale volume curve and the total porosity curve to create an effective porosity product and then introducing the effective porosity product into the Gradient Boosted Trees ML algorithm with previously expert-interpreted effective porosity volumes as an effective porosity target variable;
determining a water saturation curve based upon the shale volume curve, the total porosity curve, and the effective porosity curve, wherein the water saturation curve is also determined based upon the gamma ray measurements and the methane measurements, wherein the water saturation curve is determined by introducing the shale volume curve, the total porosity curve, and the effective porosity curve into the Gradient Boosted Trees ML algorithm with previously expert-interpreted water saturation as a water saturation target variable, wherein the Gradient Boosted Trees ML algorithm uses direct fluid evidence obtained from gas chromatography in the subsurface formation to improve accuracy by reducing ambiguity when determining a water saturation estimation derived from the first input data, and wherein the water saturation estimation also incorporates evidence gathered via the second input data to enhance precision while sustaining a detail level of the first input data;
. a permeability curve based upon the total porosity curve, the effective porosity curve, and water saturation curve, wherein the permeability is determined by creating new permeability features multiplying the total porosity curve and the water saturation curve to create a permeability product and introducing the permeability product into the Gradient Boosted Trees ML algorithm with previously expert-interpreted permeability as a permeability target variable; and
. a rock type in the subsurface formation based upon the permeability curve, wherein the rock type is determined by creating new rock type features by squaring and obtaining a base10 logarithm of the permeability curve and then introducing the base10 logarithm of the permeability curve into a Random Forest classification algorithm with previously expert-interpreted rock type as a rock type target variable.

17. The non-transitory computer-readable medium of claim 16, wherein the operations further comprise predicting a fluid volume in the subsurface formation based upon the shale volume curve, the total porosity curve, the effective porosity curve, the permeability curve, and the rock type, wherein the fluid volume is predicted by geostatistically populating a 3D grid with the shale volume curve, the total porosity curve, the effective porosity curve, the permeability curve, and the rock type and initializing the 3D grid either by equilibrium or enumeration.

18. The non-transitory computer-readable medium of claim 17, wherein the operations further comprise forecasting productivity in the subsurface formation based upon the shale volume curve, the total porosity curve, the effective porosity curve, the water saturation, the permeability, the rock type, and the fluid volume, and wherein the productivity is forecasted by a numerical simulation engine.

19. The non-transitory computer-readable medium of claim 18, wherein the operations further comprise displaying the rock type, the fluid volume, and the productivity.

20. The non-transitory computer-readable medium of claim 18, wherein the operations further comprise performing a wellsite action in response to the rock type, the fluid volume, or the productivity, wherein the wellsite action comprises generating or transmitting a signal that instructs or causes a physical action to occur.
